(19) United States
(12) Patent Application Publication
(10) Pub. No.: US 2025/0238491 A1
(43) Pub. Date: Jul. 24, 2025

(54) INFORMATION PROCESSING APPARATUS, AUTHENTICATION SYSTEM, INFORMATION PROCESSING METHOD, AND NON-TRANSITORY COMPUTER-READABLE MEDIUM

(71) Applicant: NEC Corporation, Minato-ku, Tokyo (JP)

(72) Inventors: Misuzu SHINGAI, Tokyo (JP); Katsuya NAKASHIMA, Tokyo (JP); Honami SUZUKI, Tokyo (JP); Takeo TAMURA, Tokyo (JP); Masatoshi SUGISAWA, Tokyo (JP); Shinji KUBOTANI, Tokyo (JP)

(73) Assignee: NEC Corporation, Minato-ku, Tokyo (JP)

(21) Appl. No.: 18/853,154

(22) PCT Filed: May 9, 2023
(86) PCT No.: PCT/JP2023/017488

§ 371 Date: Oct. 1, 2024

(30) Foreign Application Priority Data
May 31, 2022 (JP) 2022-088392

(51) Int. Cl. G06F 21/32; G06T 7/80

(52) U.S. Cl. CPC G06F 21/32; G06T 7/80

(57) ABSTRACT

Provided is an information processing apparatus capable of reducing the possibility of contact between a user and a member in authentication of the user. An information processing apparatus (100) includes a detection unit (101) that detects a hand presenting a reading target object including identification information of a user, and a reading unit (102) that reads biometric information from an image obtained by imaging the detected hand and reads identification information from the reading target object presented by the hand.

### TECHNICAL FIELD

The disclosure relates to an information processing apparatus, an authentication system, an information processing method, and a program.

### BACKGROUND ART

There is known a technique of performing biometric authentication by reading biometric information registered in a passport and collating the biometric information with biometric information of a user who is an examination target in an immigration inspection or the like.

As a related technique, for example, Patent Literature 1 discloses a personal authentication system apparatus including a first input means for inputting a fingerprint and a print means for printing the fingerprint input using the first input means on a personal authentication medium in a colorless manner.

When the passport is set in a barcode reading unit, the apparatus disclosed in Patent Literature 1 reads the colorless barcode printed on the face image of the passport. When the finger of the subject is pressed against the board, the fingerprint of the subject is read. The apparatus authenticates the subject by collating the content of the barcode read from the passport with the pattern of the actual fingerprint read from the subject.

### CITATION LIST

### Patent Literature

Patent Literature 1: Japanese Unexamined Patent Application Publication No. 10-Summary of Invention

### Technical Problem

When performing fingerprint authentication using an apparatus as described above, the user needs to press a finger against a substrate in order to read the fingerprint. However, in recent years, from the viewpoint of preventing the spread of infectious diseases, there has been a demand for authentication to be performed without the user having to touch such components and the like. The technique disclosed in Patent Literature 1 has a problem that a user needs to touch a predetermined member for authentication.

In view of the above-described problems, an object of the disclosure is to provide an information processing apparatus, an authentication system, an information processing method, and a program capable of reducing the possibility of contact between a user and a member in authentication of the user.

### Solution to Problem

An information processing apparatus according to the disclosure includes: a detection unit that detects a hand presenting a reading target object including identification information of a user; and a reading unit that reads biometric information from an image obtained by imaging the detected hand and reads the identification information from the reading target object presented by the hand.

An authentication system according to the disclosure includes: an information processing apparatus; and an authentication apparatus, in which the information processing apparatus includes: a detection unit that detects a hand presenting a reading target object including identification information of a user; and a reading unit that reads biometric information from an image obtained by imaging the detected hand and reads the identification information from the reading target object presented by the hand, and the authentication apparatus is configured to: acquire the biometric information and the identification information from the information processing apparatus and perform biometric authentication of the user based on the biometric information and the identification information.

An information processing method according to the disclosure causes a computer to execute: a detection step of detecting a hand that presents a reading target object including identification information of a user; and a reading step of reading biometric information from an image obtained by imaging the detected hand and reading the identification information from the reading target object presented by the hand.

A program according to the disclosure causes a computer to execute: a detection step of detecting a hand that presents a reading target object including identification information of a user; and a reading step of reading biometric information from an image obtained by imaging the detected hand and reading the identification information from the reading target object presented by the hand.

### BRIEF DESCRIPTION OF DRAWINGS

FIG. 1 is a block diagram illustrating a configuration of an information processing apparatus according to a first example embodiment.

FIG. 2 is a flowchart illustrating processing performed by the information processing apparatus according to the first example embodiment.

FIG. 3 is a block diagram illustrating a configuration of an authentication system according to a second example embodiment.

FIG. 4 is a block diagram illustrating a configuration of the authentication apparatus according to the second example embodiment.

FIG. 5 is a block diagram illustrating a configuration of the information processing apparatus according to the second example embodiment.

FIG. 6 is a first diagram illustrating a usage example of the information processing apparatus according to the second example embodiment.

FIG. 7 is a second diagram illustrating a usage example of the information processing apparatus according to the second example embodiment.

FIG. 8 is a flowchart illustrating processing performed by the information processing apparatus according to the second example embodiment.

FIG. 9 is a view illustrating a configuration of a guide unit according to a third example embodiment.

FIG. 10 is a diagram illustrating an example in which a reading target object is presented using a guide unit according to the third example embodiment.

FIG. 11 is a diagram illustrating a configuration of a guide unit according to a fourth example embodiment.

FIG. 12 is a diagram illustrating a configuration example of an information processing apparatus according to the fourth example embodiment.

FIG. 13 is a diagram illustrating a configuration of an information processing apparatus in a case where a biometric information reading apparatus according to the fourth example embodiment reads biometric information at a plurality of locations.

FIG. 14 is a diagram illustrating a configuration of a guide unit according to a fifth example embodiment.

FIG. 15 is a diagram illustrating an example in which a reading target object is presented using a guide unit according to the fifth example embodiment.

FIG. 16 is a diagram illustrating a configuration of a guide unit according to a sixth example embodiment.

FIG. 17 is a diagram illustrating an example in which a reading target object is presented using a guide unit according to the sixth example embodiment.

FIG. 18 is a diagram illustrating the information processing apparatus in the state illustrated in FIG. 17 as viewed from the user side.

FIG. 19 is a block diagram illustrating a hardware configuration of a computer that implements an information processing apparatus and the like.

### EXAMPLE EMBODIMENT

Hereinafter, example embodiments of the disclosure will be described in detail with reference to the drawings. In the drawings, the same or corresponding elements are denoted by the same reference signs. For clarity of description, redundant description will be omitted as necessary.

### First Example Embodiment

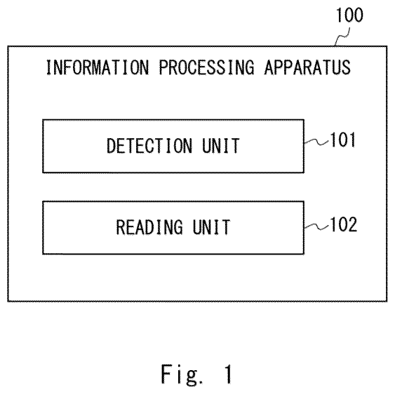

First, a first example embodiment will be described with reference to FIG. 1. FIG. 1 is a block diagram illustrating a configuration of an information processing apparatus 100 according to the present example embodiment. The information processing apparatus 100 includes a detection unit 101 and a reading unit 102.

The detection unit 101 detects a hand presenting a reading target object including identification information of a user. The reading unit 102 reads the biometric information from the image obtained by imaging the hand detected by the detection unit 101, and reads the identification information from the reading target object presented by the hand.

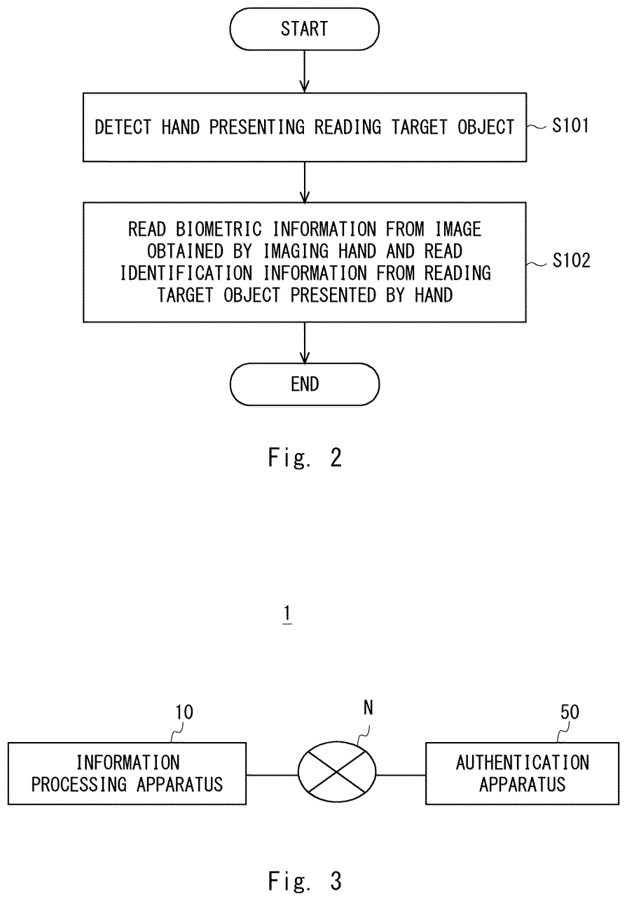

Next, processing performed by the information processing apparatus 100 according to the present example embodiment will be described with reference to FIG. 2. FIG. 2 is a flowchart illustrating processing performed by the information processing apparatus 100.

First, the detection unit 101 detects a hand that presents a reading target object including identification information of the user (S101). Next, the reading unit 102 reads the biometric information from the image obtained by imaging the hand detected by the detection unit 101, and reads the identification information from the reading target object presented by the hand (S102). The reading unit 102 may read the biometric information and the identification information at the same timing or at different timings.

With such a configuration, according to the information processing apparatus 100 according to the present example embodiment, it is possible to reduce the possibility of contact between the user and the member in the authentication of the user.

### Second Example Embodiment

Next, a second example embodiment will be described. The second example embodiment is a specific example of the first example embodiment described above.

### (Configuration and Outline of Authentication System 1)

An authentication system 1 according to the present example embodiment will be described with reference to FIG. 3. FIG. 3 is a block diagram illustrating a configuration of the authentication system 1. As illustrated in FIG. 3, the authentication system 1 includes an information processing apparatus 10 and an authentication apparatus 50. The information processing apparatus 10 and the authentication apparatus 50 are connected via a network N. Here, the network N is a wired or wireless communication line.

The authentication system 1 is an information processing system for performing biometric authentication of a user by using biometric information obtained from the user who is a subject of the biometric authentication. The authentication system 1 is used, for example, in an airport, an ATM, a building, a station, a store, a hospital, a public facility, or the like, but is not limited thereto.

As the biometric information, for example, a fingerprint shape pattern, a vein shape pattern, or a combination thereof can be used. The biometric information is not limited thereto, and various types of information with which it is possible to calculate a feature amount indicating a physical feature unique to the user may be used as the biometric information. The biometric information is not limited thereto, and may be various types of biometric information that can be read together with the hand presenting the reading target object.

In the authentication system 1, the information processing apparatus 10 detects a hand presenting a reading target object including identification information of the user. Furthermore, the information processing apparatus 10 reads the biometric information from the image obtained by imaging the detected hand, and reads the identification information from the reading target object presented by the hand.

The identification information is information for uniquely specifying the user. The identification information may be, for example, a character string including alphabetic letters, numbers, and the like. The identification information is, for example, a passport number described in a passport. Furthermore, the identification information may be biometric information of the user. For example, when a fingerprint image to be used for fingerprint authentication is stored in an IC chip built in the passport, the fingerprint image can be used as identification information.

The identification information may be a combination of a plurality of pieces of information. For example, information obtained by combining a plurality of pieces of information among information such as a user's name, date of birth, address, and biometric information may be used as the identification information. The identification information may be described on the reading target object by printing or the like, or may be stored in an IC chip or the like built in the reading target object.

The reading target object may be an article including identification information. The reading target object may be, for example, a document in which identification information is described. The reading target object may include, for example, a passport, a refugee travel document, a driver's license, a health insurance card, or a My Number card. An identification card or the like other than these may be used as the reading target object.

The reading target object may be a document or the like incorporating an IC chip in which identification information is stored. The reading target object may be an information terminal that stores identification information. The information terminal may be, for example, a smartphone, a mobile phone terminal, a tablet terminal, or the like possessed by the user. The information terminal may be a wearable terminal such as a smartwatch. Since these are examples, the reading target object may be various media other than the above.

For example, it is assumed that the authentication system 1 is used in an immigration inspection at an airport. The reading target object is a passport or the like presented by the user in order to pass the immigration inspection. In the authentication system 1, the information processing apparatus 10 detects a hand of the user presenting the reading target object, and reads the biometric information from the detected hand. Furthermore, the information processing apparatus 10 reads the identification information from the reading target object presented by the user's hand.

The information processing apparatus 10 controls biometric authentication of the user by using the read biometric information and identification information. Specifically, the information processing apparatus 10 transmits an authentication request including the biometric information and the identification information to the authentication apparatus 50. The authentication apparatus 50 performs authentication in response to an authentication request from the information processing apparatus 10, and transmits an authentication result to the information processing apparatus 10. The information processing apparatus 10 receives the authentication result from the authentication apparatus 50.

The information processing apparatus 10 instructs to unlock a predetermined gate apparatus provided in the airport in response to successful authentication. As a result, the user who has succeeded in the authentication can pass the immigration inspection.

### (Configuration of Authentication Apparatus 50)

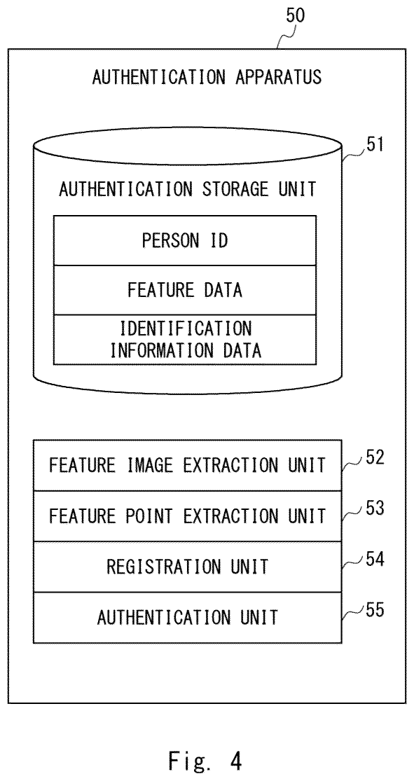

Next, a configuration of the authentication apparatus 50 will be described with reference to FIG. 4. FIG. 4 is a block diagram illustrating a configuration of the authentication apparatus 50. The authentication apparatus 50 is a computer that performs biometric authentication of the user in response to an authentication request from the information processing apparatus 10.

The authentication apparatus 50 acquires the biometric information and the identification information of the user from the information processing apparatus 10, and performs biometric authentication of the user based on the acquired biometric information and identification information. For example, the authentication apparatus 50 receives an image related to the biometric information of the user from the information processing apparatus 10, and extracts a predetermined feature image from the received image to authenticate the person. The feature image is, for example, a fingerprint pattern image. The authentication apparatus 50 transmits an authentication result to the information processing apparatus 10.

The authentication apparatus 50 mainly includes an authentication storage unit 51, a feature image extraction unit 52, a feature point extraction unit 53, a registration unit 54, and an authentication unit 55.

The authentication storage unit 51 stores a person ID related to a person registered in advance, feature data of the person, and identification information data of the person in association with each other. The identification information data is, for example, a passport number described in the passport.

The feature image extraction unit 52 detects a feature region included in an image relating to biometric information of the user and outputs the feature region to the feature point extraction unit 53. The feature point extraction unit 53 extracts a feature point from the feature region detected by the feature image extraction unit 52, and outputs data regarding the feature point to the registration unit 54. The data relating to feature points is a set of extracted feature points.

The registration unit 54 newly issues a person ID when registering the feature data and the identification information data. The registration unit 54 registers the issued person ID, the feature data extracted from the registered image, and the identification information data of the person in the authentication storage unit 51 in association with each other.

The authentication unit 55 collates the feature data extracted from the image relating to the biometric information of the user with the feature data in the authentication storage unit 51. In addition, the authentication unit 55 collates the identification information of the user acquired from the information processing apparatus 10 with the identification information data in the authentication storage unit 51. The authentication unit 55 determines that the authentication is successful in a case where the feature data that matches the biometric information of the user exists and the identification information of the user and the identification information data match.

On the other hand, when the condition is not satisfied, the authentication unit 55 determines that the authentication has failed. For example, in a case where there is no feature data that matches the biometric information of the user, the authentication unit 55 determines that the authentication has failed. In addition, the authentication unit 55 determines that the authentication has failed in a case where there is feature data that matches the biometric information of the user, but the identification information and the identification information data do not match.

The authentication unit 55 transmits information regarding success or failure of authentication to the information processing apparatus 10. In addition, in a case where the authentication is successful, the authentication unit 55 specifies a person ID associated with the successful feature data and identification information data, and notifies the information processing apparatus 10 of an authentication result including the specified person ID.

### (Configuration of Information Processing Apparatus 10)

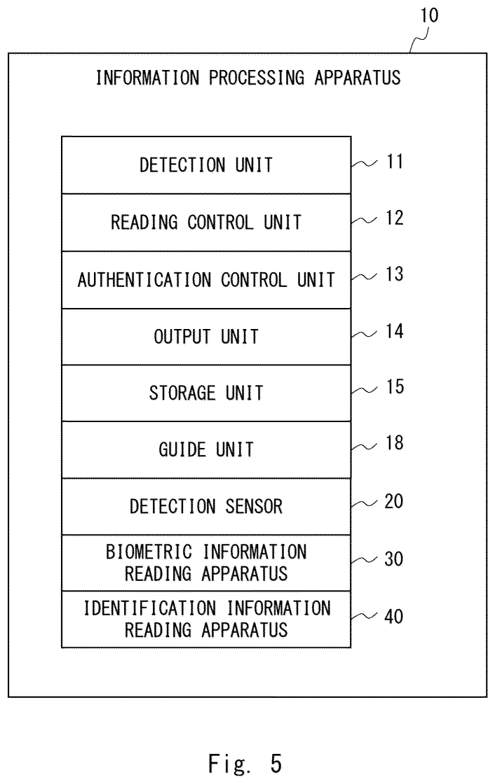

Next, a configuration of the information processing apparatus 10 will be described with reference to FIG. 5. FIG. 5 is a block diagram illustrating a configuration of the information processing apparatus 10. The information processing apparatus 10 is an example of the information processing apparatus 100 described above. The information processing apparatus 10 is a computer for performing information processing according to the present example embodiment.

The information processing apparatus 10 includes a detection unit 11, a reading control unit 12, an authentication control unit 13, an output unit 14, a storage unit 15, a guide unit 18, a detection sensor 20, a biometric information reading apparatus 30, and an identification information reading apparatus 40.

The detection unit 11 is an example of the detection unit 101 described above. The detection unit 11 detects a hand of the user presenting the reading target object including the identification information of the user. Specifically, the detection unit 11 detects the hand based on the data acquired by the detection sensor 20. The detection sensor 20 may include, for example, a camera, a distance measuring sensor, a pressure sensor, or the like.

In a case where the detection sensor 20 is a camera, the detection unit 11 detects a hand of the user presenting the reading target object from an image obtained by imaging the hand presenting the reading target object on a predetermined mounting table. The predetermined mounting table is, for example, a table provided in a space where an immigration inspection is performed at an airport. The detection unit 11 acquires the captured image from the detection sensor 20, and detects the user's hand presenting the reading target object from the captured image. The detection unit 11 can detect the user's hand presenting the reading target object using a known image recognition technology.

Furthermore, in a case where the detection sensor 20 is a distance measuring sensor, the detection unit 11 detects a hand of a user presenting a reading target object on a predetermined mounting table based on distance measurement data acquired from the distance measuring sensor. For example, the detection unit 11 obtains a difference between the distance measurement data of the detection target region in a state where no article or the like is placed on the mounting table and the distance measurement data acquired by the detection sensor 20. The detection unit 11 detects the user's hand presenting the reading target object by detecting the unevenness existing in the detection target region using the difference. For example, in a case where a predetermined level or more of unevenness is generated within a predetermined range of the mounting table, the detection unit 11 detects a hand of the user presenting the reading target object on the mounting table.

In a case where the detection sensor 20 is a pressure sensor, the detection unit 11 detects a hand presenting a reading target object based on pressure data acquired from a pressure sensor provided on a predetermined mounting table. For example, the detection unit 11 determines whether the pressure applied to the mounting table is equal to or higher than a predetermined threshold value, and detects the user's hand presenting the reading target object according to the determination result. The detection unit 11 detects the user's hand when the pressure applied to the mounting table is equal to or higher than a predetermined threshold value, and does not detect the user's hand when the pressure is less than the threshold value.

Since the detection method described above is an example, the detection unit 11 may detect the user's hand presenting the reading target object using various other methods.

The reading control unit 12 is an example of the reading unit 102 described above. The reading control unit 12 controls the biometric information reading apparatus 30 and the identification information reading apparatus 40. The reading control unit 12 controls the biometric information reading apparatus 30 and the identification information reading apparatus 40 to read the biometric information from the image obtained by imaging the hand detected by the detection unit 11 and to read the identification information from the reading target object presented by the hand.

The reading control unit 12 may control each of the biometric information reading apparatus 30 and the identification information reading apparatus 40 to read the biometric information and the identification information at the same timing. In addition, the reading control unit 12 may control the biometric information reading apparatus 30 and the identification information reading apparatus 40 to read the biometric information and the identification information at different timings.

An example in which the reading control unit 12 controls each of the biometric information reading apparatus 30 and the identification information reading apparatus 40 to read the biometric information and the identification information at different timings will be described. For example, the reading control unit 12 first causes the biometric information reading apparatus 30 to read the biometric information to acquire the biometric information. Subsequently, the reading control unit 12 determines whether the quality of the biometric information is equal to or higher than a predetermined value, and causes the identification information reading apparatus 40 to read the identification information according to the determination result. The reading control unit 12 causes the identification information to be read when it is determined that the quality of the biometric information is equal to or higher than a predetermined value, and does not cause the identification information to be read when the quality is lower than the predetermined value.

In a case where the biometric information is not read, the reading control unit 12 may notify the user that the biometric information is to be read again. Furthermore, the reading control unit 12 may notify the user to change the posture of the hand or the like so as to improve the quality of the biometric information.

Here, the quality of the biometric information indicates whether the biometric information is in a state suitable for biometric authentication. For example, the higher the quality of the biometric information, the more suitable the biometric information is for the biometric authentication, and the lower the quality of the biometric information, the less suitable the biometric information is for the biometric authentication.

For example, it is assumed that a fingerprint image obtained by imaging a fingerprint of a user is used as the biometric information. The quality of the fingerprint image can be specified, for example, by calculating a quality value using a well-known index. As an index of the quality of a fingerprint image, for example, NIST fingerprint image quality (NIST Fingerprint Image Quality, NFIQ) by the National Institute of Standards and Technology (National Institute of Standards and Technology, NIST) is known.

The reading control unit 12 can calculate the quality value of the fingerprint image using NFIQ or the like as an index and calculate the quality value based on the calculation result. The reading control unit 12 may calculate the quality value using another index.

In addition, the reading control unit 12 may receive a result of visually determining the quality of the fingerprint image by a person and calculate the quality value. For example, the reading control unit 12 may receive a result visually determined by an administrator or the like of the authentication system 1 from an input unit (not illustrated) and set the result as a quality value. The quality value may be represented by a binary value such as “OK” or “NG,” or may be represented in multiple stages.

The authentication control unit 13 controls biometric authentication of the user by using the read biometric information and identification information. Specifically, the authentication control unit 13 transmits an authentication request including the biometric information and the identification information to the authentication apparatus 50. The authentication control unit 13 receives the authentication result from the authentication apparatus 50.

The output unit 14 is an output apparatus for outputting predetermined information. The output unit 14 outputs, for example, the guidance information generated by the guide unit 18. The output unit 14 may be, for example, a display, a speaker, a lamp, a vibrator, or the like. Furthermore, the guide unit 18 may be a projector or the like for projecting guidance information on a mounting table or the like.

The storage unit 15 is a storage device that stores a program for realizing each function of the information processing apparatus 10. In addition, the storage unit 15 stores the guidance information generated by the guide unit 18.

The guide unit 18 guides the hand and the reading target object to a state in which the biometric information can be read from the hand and the identification information can be read from the reading target object. For example, the guide unit 18 generates guidance information for guiding the hand and the reading target object to a state in which the biometric information can be read from the hand and the identification information can be read from the reading target object. The guide unit 18 outputs the guidance information to the output unit 14, and causes the output unit 14 to output the guidance information. The guide unit 18 may store the guidance information in the storage unit 15.

The guidance information is information for guiding the hand and the reading target object using, for example, characters, images, sounds, vibrations, or the like. The guidance information is, for example, voice information for outputting a voice message such as “Place the passport on the mounting table and place your hand on the passport.”

The guidance information may include information for instructing a positional relationship between a hand and a reading target object. For example, the guidance information may be a voice message such as “Place the passport on the mounting table and place your hand on the passport so that the finger does not overlap the passport.” The guide unit 18 generates such a voice message and causes the output unit 14 to output the voice message. As a result, the user can change the positions of the hand and the reading target object according to the guidance information.

The guidance information may be information for displaying such a message using characters or images. For example, the guidance information may be information for projecting such a message on the mounting table by a projection apparatus such as a projector.

The guidance information may be a guidance image for guiding the hand and the reading target object to a state in which the biometric information can be read from the hand and the identification information can be read from the reading target object. The guidance image may include an image, such as an arrow symbol, to guide the hand and the reading target object to a predetermined position, respectively. By visually recognizing the guidance information, the user can move the hand and the reading target object to a predetermined position in the above-mentioned state.

The detection sensor 20 is a sensor for detecting a hand of the user presenting the reading target object. The detection sensor 20 may be, for example, a camera, a distance measuring sensor, a pressure sensor, or the like.

For example, it is assumed that the detection sensor 20 is a camera. The detection sensor 20 images a region including a hand presenting a reading target object on a predetermined mounting table. The detection sensor 20 outputs the captured image acquired by imaging to the detection unit 11. The light used for imaging may be visible light or light other than visible light (for example, infrared light).

In addition, it is assumed that the detection sensor 20 is a distance measuring sensor. The detection sensor 20 is, for example, a time of flight (ToF) sensor. The detection sensor 20 images a region including a hand presenting a reading target object on a predetermined mounting table. Specifically, the detection sensor 20 irradiates a subject with laser diode (LD) light in an infrared region, and receives the LD light reflected by the subject by an imaging element for infrared light. The detection sensor 20 calculates a distance between the subject and the detection sensor 20 by detecting a time difference from irradiation to light reception for each pixel. The detection sensor 20 measures the calculated distance to the subject for each pixel. The detection sensor 20 outputs the measurement result to the detection unit 11 as distance measurement data.

Note that the detection sensor 20 is not limited to the ToF sensor, and various sensors capable of detecting the distance between the detection sensor 20 and the subject may be used.

It is assumed that the detection sensor 20 is a pressure sensor. The detection sensor 20 is provided on a predetermined mounting table, and detects a pressure applied to the mounting table. The detection sensor 20 outputs the output value as pressure data to the detection unit 11. A plurality of detection sensors 20 may be provided on the mounting table.

Since the above-described camera, distance measurement sensor, and pressure sensor are examples of the detection sensor 20, other sensors may be used as the detection sensor 20.

Under the control of the reading control unit 12, the biometric information reading apparatus 30 reads the biometric information from the image obtained by imaging the hand detected by the detection unit 11.

The biometric information reading apparatus 30 may be, for example, an OCT (Optical Coherence Tomography) apparatus that acquires a pattern image on the surface or inside of an observation target using a technique of OCT. When irradiating the observation target with a light beam, the biometric information reading apparatus 30 acquires a pattern image of the surface or the inside of the observation target using interference between scattered light from the inside of the observation target and reference light. The observation target is, for example, a user's finger. The biometric information reading apparatus 30 acquires, for example, a fingerprint image indicating a fingerprint pattern of the epidermis or dermis of the user's finger.

The biometric information reading apparatus 30 can be provided above or below a predetermined mounting table. For example, when the biometric information reading apparatus 30 is provided above the mounting table, the user turns his/her palm upward. Furthermore, in a case where the biometric information reading apparatus 30 is provided below the mounting table, the user turns his/her palm downward. As a result, the biometric information reading apparatus 30 can read the biometric information of the user.

Further, by using the OCT apparatus, the biometric information reading apparatus 30 can read the fingerprint through the reading target object. For example, it is assumed that the biometric information reading apparatus 30 is provided below the mounting table. In addition, it is assumed that the user places a hand on the reading target object so as to overlap the reading target object. In this case, a reading target object exists between the hand and the biometric information reading apparatus 30, but the biometric information reading apparatus 30 can read the fingerprint from below the mounting table through the reading target object. Therefore, the biometric information reading apparatus 30 can read the fingerprint in a state where the user does not touch the mounting table.

Furthermore, by using the OCT apparatus, the information processing apparatus 10 can be configured such that a sheet member such as paper or a film is placed on a mounting table and a reading target object is placed thereon. As a result, it is possible to prevent the user's hand or the reading target object from coming into contact with the mounting table or the like. The sheet member can be molded with a predetermined thickness so as to be able to transmit light used in the OCT apparatus.

Further, by making the case of the reading target object (for example, the passport) transparent, the biometric information reading apparatus 30 can read the biometric information with high accuracy.

Note that the biometric information reading apparatus 30 is not limited to the OCT apparatus. For example, the biometric information reading apparatus 30 may be a camera or the like that images a hand presenting a reading target object. In this case, the biometric information reading apparatus 30 detects the user's finger region from the captured image and reads the user's fingerprint pattern from the finger region. The biometric information reading apparatus 30 may be, for example, a 3D fingerprint scanner capable of reading a three-dimensional fingerprint image. The biometric information reading apparatus 30 may use visible light or light (for example, infrared light) other than the visible light for imaging the finger.

The identification information reading apparatus 40 reads the identification information of the user from the reading target object presented by the hand detected by the detection unit 11 under the control of the reading control unit 12. The identification information reading apparatus 40 can be provided on a predetermined mounting table. The identification information is, for example, a passport number of the passport. The identification information may be described on the reading target object by printing or the like, or may be stored in an IC chip or the like built in the reading target object.

The identification information reading apparatus 40 is, for example, a scanner including an imaging element. In this case, the identification information reading apparatus 40 images the passport presented by the user, identifies characters from the captured image, and outputs the identified character information to the authentication control unit 13.

When the identification information is associated with the reading target object by a method other than characters, the identification information reading apparatus 40 may include a means for reading the identification information instead of the scanner. For example, the identification information reading apparatus 40 may be a barcode reader, a magnetic information reading apparatus, a near field communication apparatus, or the like. When the user holds the reading target object over the identification information reading apparatus 40, the identification information reading apparatus 40 reads the identification information from the reading target object.

Each configuration of the authentication system 1 has been described above with reference to FIGS. 3 to 5. The configuration of the authentication system 1 described above is merely an example, and can be appropriately changed. For example, the authentication system 1 may be configured using an apparatus or the like in which a plurality of configurations are aggregated. Furthermore, the functions of the information processing apparatus 10 and the authentication apparatus 50 may be integrated in the same apparatus. Then, each functional unit in each of the information processing apparatus 10 and the authentication apparatus 50 may be subjected to distributed processing using a plurality of apparatuses or the like.

### (Usage Example of Information Processing Apparatus 10)

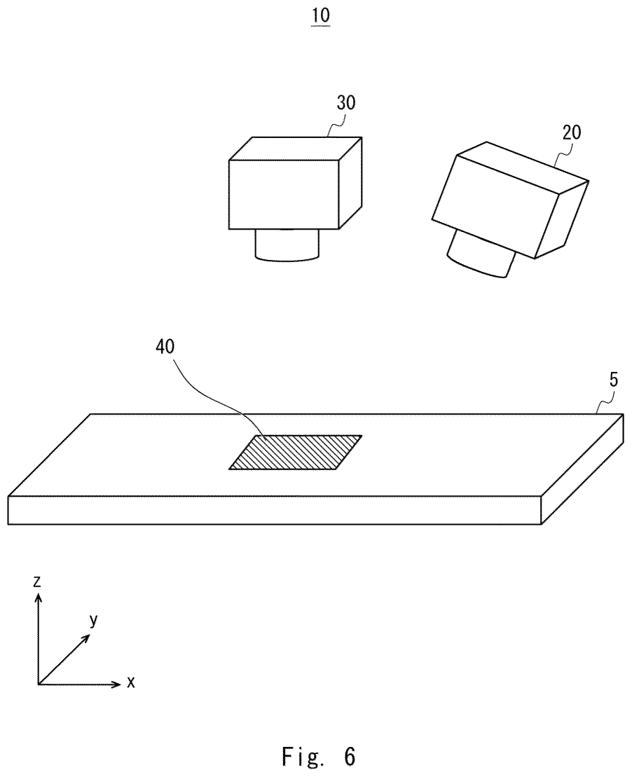

Next, a usage example of the information processing apparatus 10 according to the present example embodiment will be described with reference to FIG. 6. FIG. 6 is a first diagram illustrating a usage example of the information processing apparatus 10. As illustrated in the figure, the information processing apparatus 10 further includes a mounting table 5 in addition to the above-described configuration.

The right-handed xyz coordinates shown in FIG. 6 and the other drawings are for convenience of description of the positional relationship of the components. Normally, a z-axis plus direction is vertically upward, and an xy plane is a horizontal plane, which are common between the drawings.

As shown in the figure, the mounting table 5 is, for example, a plate-shaped member having a horizontal main surface. The mounting table 5 is not limited to this, and for example, an upper surface of a box-shaped member, an apparatus, or the like may be used. The mounting table 5 may have a predetermined angle so that the hand and the reading target object can be easily presented.

In the example of FIG. 6, the detection sensor 20 and the biometric information reading apparatus 30 are provided above the mounting table 5. The detection sensor 20 is provided at a position where the user's hand presenting the reading target object can be detected. For example, the detection sensor 20 is provided at a position where a region including at least the user's hand can be captured. Although FIG. 6 illustrates an example in which the detection sensor is a camera or a distance measuring sensor, the detection sensor 20 may be a pressure sensor provided on the mounting table 5.

Further, the biometric information reading apparatus 30 is provided at a position where biometric information can be read from an image obtained by imaging the detected hand. For example, the biometric information reading apparatus 30 is provided at a position where a region including at least a finger of a user presenting a reading target object can be captured.

The mounting table 5 includes an identification information reading apparatus 40 that reads a reading target object. The identification information reading apparatus 40 is provided at a position where the identification information can be read from the reading target object while the user is presenting the reading target object.

For example, as illustrated in FIG. 6, the identification information reading apparatus 40 is provided with a reading surface for reading a reading target object on the upper surface of the mounting table 5. The reading surface is provided substantially horizontally with respect to the mounting table 5. When the user places the reading target object on the reading surface, the identification information reading apparatus 40 reads the identification information from the reading target object. In this state, the biometric information reading apparatus 30 reads the biometric information from the user's hand. Note that, in the example illustrated in FIG. 6, since the biometric information reading apparatus 30 is provided above the mounting table 5, the user presents the reading target object in a state where a palm on which the reading target object is presented faces upward.

A flow of biometric authentication will be described using a specific example. For example, it is assumed that the reading target object is a passport. In the passport, information such as a passport number, a name, a nationality, and a date of birth is described on a predetermined page. Alternatively, the passport may incorporate an IC chip including these pieces of information. The identification information is, for example, a passport number.

The user presents the passport on the reading surface of the identification information reading apparatus 40, and turns the palm presenting the passport upward. For example, the user opens the hand holding the passport while holding the passport on the mounting table 5 with the back of the hand, and turns the palm upward. The detection sensor 20 images the user's hand presenting the passport, and outputs the captured image to the detection unit 11. The detection unit 11 detects the user's hand from the captured image.

The reading control unit 12 controls the biometric information reading apparatus 30 and the identification information reading apparatus 40. The reading control unit 12 controls the biometric information reading apparatus 30 and the identification information reading apparatus 40 so as to read the biometric information from the image obtained by imaging the detected hand and to read the passport number from the passport presented by the hand.

The biometric information reading apparatus 30 reads, for example, a fingerprint image as biometric information. The identification information reading apparatus 40 reads the passport number from the passport. The identification information reading apparatus 40 may read a passport number from character information of a predetermined page, or may read a passport number from a built-in IC chip.

The authentication control unit 13 makes an authentication request to the authentication apparatus 50 using the read fingerprint image and passport number. The authentication control unit 13 receives an authentication result from the authentication apparatus 50, and outputs the authentication result and the like according to the authentication result.

As described above, in a state where the user presents the reading target object, the biometric information reading apparatus 30 can read the biometric information from the hand presenting the reading target object, and the identification information reading apparatus 40 can read the identification information from the reading target object. In addition, since the user places his/her hand on the reading target object possessed by the user, the user can perform biometric authentication without contacting the information processing apparatus 10 or the mounting table 5.

Note that the positions of the detection sensor 20 and the biometric information reading apparatus 30 are not limited to those illustrated in FIG. 6. For example, the biometric information reading apparatus 30 may be provided below the mounting table 5 as described below.

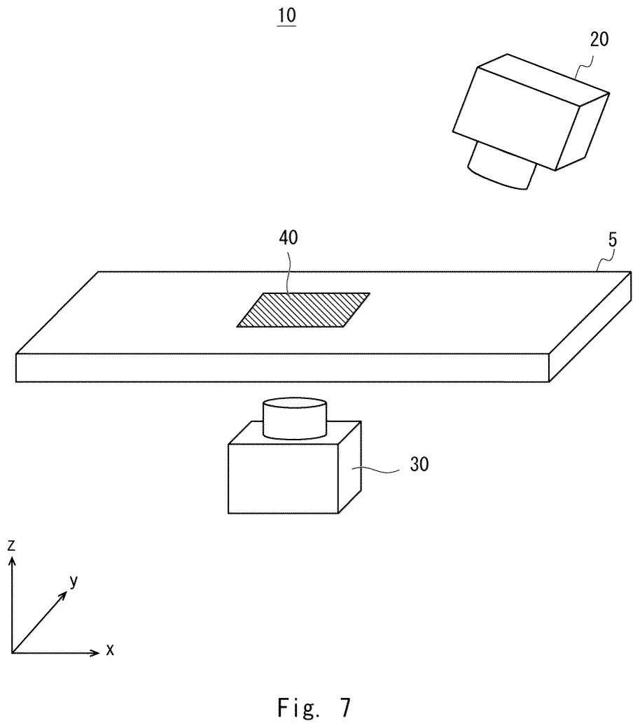

FIG. 7 is a second diagram illustrating a usage example of the information processing apparatus 10. In the example illustrated in FIG. 7, unlike FIG. 6, the biometric information reading apparatus 30 is provided below the mounting table 5. The user performs the fingerprint authentication in a state where the palm presenting the reading target object faces downward. In this manner, the user can more easily present the reading target object on the mounting table 5.

### (Processing of Information Processing Apparatus 10)

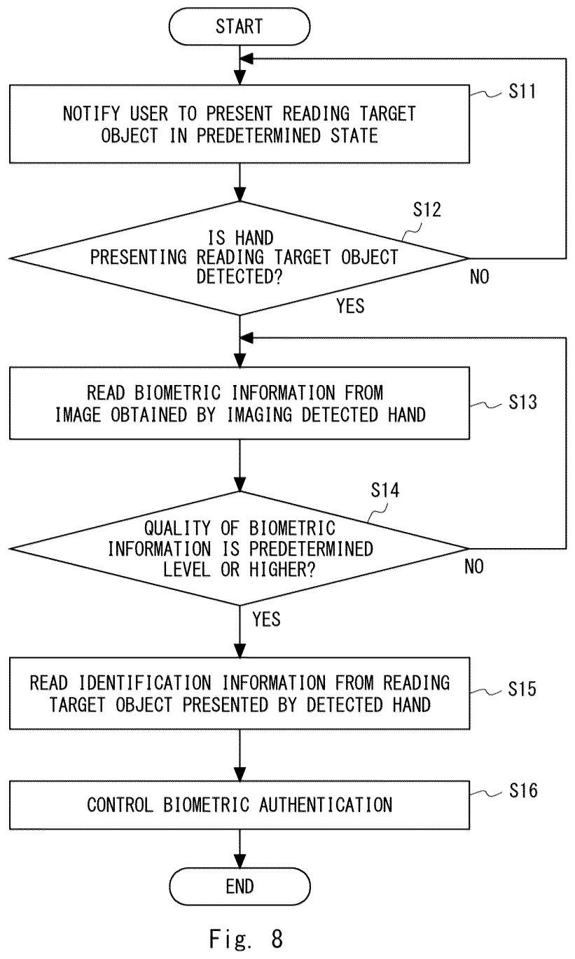

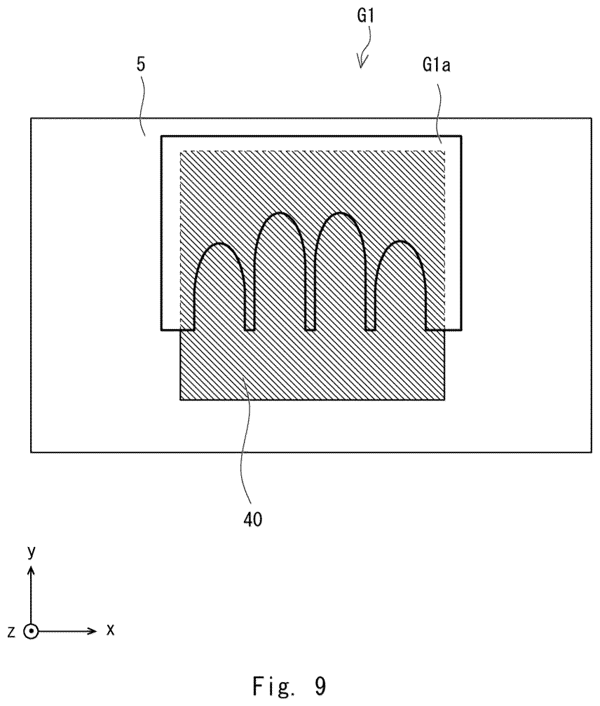

Next, processing performed by the information processing apparatus 10 will be described with reference to FIG. 8. FIG. 8 is a flowchart illustrating processing performed by the information processing apparatus 10.

First, the guide unit 18 notifies the user to present the reading target object in a predetermined state (S11). The predetermined state is a state in which the biometric information can be read from the user's hand and the identification information can be read from the reading target object. The guide unit 18 generates guidance information for guiding the hand and the reading target object to the state, and outputs the guidance information to the output unit 14.

For example, the guide unit 18 presents the reading target object on the reading surface of the identification information reading apparatus 40 provided on the mounting table, and generates a voice message for notifying the user to place the hand on the reading target object. The voice message is, for example, “Place the passport on the reading surface of the mounting table and place your hand on the passport.” The guide unit 18 causes the output unit 14 to output the generated guidance information.

The guide unit 18 may generate display information for displaying the message by an image and cause the output unit 14 to output the display information. Further, the guide unit 18 may generate a guidance image to be projected on the mounting table in order to guide the hand and the reading target object. The guide unit 18 may store the guidance image in the storage unit 15.

Next, the detection unit 11 determines whether the user's hand presenting the reading target object is detected using the detection sensor 20 (S12). The detection sensor 20 is, for example, a camera, a distance measuring sensor, a pressure sensor, or the like. The detection sensor 20 outputs a captured image, distance measurement data, pressure data, or the like to the detection unit 11. The detection unit 11 detects a hand of the user presenting the reading target object based on the captured image or the like.

When it is not detected that the user places a hand on the reading target object (NO in S12), the detection unit 11 returns to the processing of step S11. When it is detected that the user places a hand on the reading target object (YES in S12), the reading control unit 12 reads the user biometric information from the image obtained by imaging the detected hand (S13). Specifically, the reading control unit 12 controls the biometric information reading apparatus 30 to read the biometric information of the user. Here, the reading control unit 12 causes the fingerprint image of the hand presenting the reading target object as the biometric information.

Subsequently, the reading control unit 12 determines whether the quality of the read biometric information is equal to or higher than a predetermined value (S14). For example, the reading control unit 12 calculates the quality value of the biometric information using a known index or the like. The reading control unit 12 determines whether the calculated quality value is equal to or higher than a predetermined value. For example, the reading control unit 12 determines whether the quality value is equal to or higher than a predetermined value by comparing the quality value with a preset threshold value.

When it is determined that the quality value is less than the threshold value (NO in S14), the reading control unit 12 returns to the processing of step S13. When it is determined that the quality value is equal to or higher than the threshold value (YES in S14), the reading control unit 12 reads the identification information of the user from the reading target object presented by the detected hand (S15).

Specifically, the reading control unit 12 controls the identification information reading apparatus 40 to read the identification information from the reading target object. Here, the reading control unit 12 reads the passport number stored in the IC chip in the reading target object. In this manner, the reading control unit 12 can read the biometric information from the image obtained by imaging the detected hand and read the identification information from the reading target object presented by the hand.

Subsequently, the authentication control unit 13 controls biometric authentication (S16). The authentication control unit 13 transmits an authentication request including the read biometric information and identification information to the authentication apparatus 50. For example, the authentication control unit 13 transmits an authentication request including the read fingerprint image and passport number to the authentication apparatus 50. The authentication apparatus 50 performs fingerprint authentication of the user in response to the authentication request, and transmits an authentication result to the information processing apparatus 10. The information processing apparatus 10 receives the authentication result from the authentication apparatus 50.

The authentication control unit 13 may cause the output unit 14 to display the authentication result. In addition, the authentication control unit 13 may control another apparatus or the like according to the success of the authentication. For example, in a case where the authentication system 1 is used in an immigration inspection at an airport, the authentication control unit 13 controls unlocking of a predetermined gate apparatus in response to successful authentication. As a result, the user can pass the immigration inspection.

Note that, in the above description, an example has been used in which the information processing apparatus 10 first reads the biometric information and then reads the reading target object, but the present disclosure is not limited thereto. The information processing apparatus 10 may read the biometric information and the reading target object at the same timing.

As described above, in the authentication system 1 according to the present example embodiment, the information processing apparatus 10 detects the hand presenting the reading target object including the identification information of the user. Furthermore, the information processing apparatus 10 reads the biometric information from the image obtained by imaging the detected hand, and reads the identification information from the reading target object presented by the hand. With such a configuration, according to the authentication system 1, it is possible to perform biometric authentication of the user while reducing the possibility of contact between the user and the member.

Furthermore, the information processing apparatus 10 determines whether the quality of the biometric information is equal to or higher than a predetermined value, and can read the identification information in a case where it is determined that the quality is equal to or higher than the predetermined value, so that the biometric authentication can be efficiently performed.

Furthermore, since the information processing apparatus 10 includes the guide unit 18 that guides the hand and the reading target object to a state in which the biometric information can be read from the hand and the identification information can be read from the reading target object, it is possible to notify the user of appropriate positions of the hand and the reading target object.

### Modified Example of Second Example Embodiment

In the second example embodiment described above, the passport number is used as an example of the identification information, but the present disclosure is not limited thereto. When the biometric information is stored in an IC chip or the like incorporated in the reading target object, the identification information may be the stored biometric information. In a case where the biometric information is described in the reading target object, the authentication control unit 13 can perform the biometric information by collating the biometric information stored in the reading target object with the biometric information read by the biometric information reading apparatus 30.

Note that the configuration and the flow of processing of the information processing apparatus 10 are the same as those in FIGS. 5 and 8, and thus are not illustrated.

Here, as an example, the biometric information stored in the IC chip in the reading target object is referred to as “registration biometric information.” Similarly to the feature data stored in the authentication storage unit 51 of the authentication apparatus 50 described above, the registration biometric information is data regarding the feature point of the biometric information extracted from the registration image.

The authentication control unit 13 collates the feature data extracted from the image relating to the biometric information read by the biometric information reading apparatus 30 with the registration biometric information in the IC chip. When the feature data matches the registration biometric information, the authentication control unit 13 determines that the authentication has succeeded. On the other hand, in a case where the biometric information of the user and the registration biometric information do not match, the authentication control unit 13 determines that the authentication has failed.

The authentication control unit 13 may determine whether the biometric information is stored in the reading target object, and determine whether to perform the processing of the second example embodiment described above or the processing as in the present modified example according to the determination result. In this case, when the biometric information is stored in the reading target object, the authentication control unit 13 performs the processing as in the present modified example. The processing of the present modified example may be performed by the information processing apparatus 10, or may be performed by the authentication apparatus 50 as in the above-described second example embodiment.

### Third Example Embodiment

First, a third example embodiment will be described. The third example embodiment is different from the second example embodiment described above in the aspect of the guide unit 18. Since the configuration other than the guide unit 18 is similar to that of the second example embodiment, description of overlapping contents is omitted.

The guide unit G1 according to the present example embodiment will be described with reference to FIG. 9. FIG. 9 is a diagram illustrating a configuration of the guide unit G1. The guide unit G1 is an example of the guide unit 18 described above. As illustrated in the figure, the guide unit G1 is provided on the mounting table 5. The guide unit G1 is configured using a finger guide member G1a having a shape corresponding to the shape of the finger.

The finger guide member G1a guides the hand and the reading target object to a state in which the biometric information reading apparatus 30 can read the biometric information from the hand and the identification information reading apparatus 40 can read the identification information from the reading target object.

The finger guide member G1a has an insertion port for inserting a reading target object. The insertion port is provided, for example, to insert the reading target object from the lower side (y-axis minus direction side) toward the upper side (y-axis plus direction side) in FIG. 9.

The finger guide member G1a may be made of, for example, acrylic, glass, polycarbonate, or the like. The finger guide member G1a may be, for example, a plate-like member. The finger guide member G1a is made of a transparent material, so that the user can visually recognize the inserted reading target object. The finger guide member G1a may not be made of a transparent material, and may be made of a material other than the above-described material.

The finger guide member G1a can be formed by molding these materials into a shape corresponding to the shape of the user's finger. For example, the finger guide member G1a can be formed by cutting out a material into the shape.

As illustrated in FIG. 9, the finger guide member G1a can be molded to correspond to the shapes of four fingers, for example. The present disclosure is not limited to this, and the finger guide member G1a may be molded so as to correspond to the shapes of 1 to 3 or 5 fingers. Further, the finger guide member G1a may be molded in another shape in which the user can grasp the guiding position of the finger. For example, in the finger guide member G1a, a finger shape portion may have an arc shape or the like.

The finger guide member G1a is provided such that at least a partial region overlaps the reading surface of the identification information reading apparatus 40. As a result, in a state where the user inserts the reading target object into the finger guide member G1a and places the finger according to the finger guide member G1a, the identification information reading apparatus 40 reads the reading target object and the biometric information reading apparatus 30 reads the biometric information of the finger.

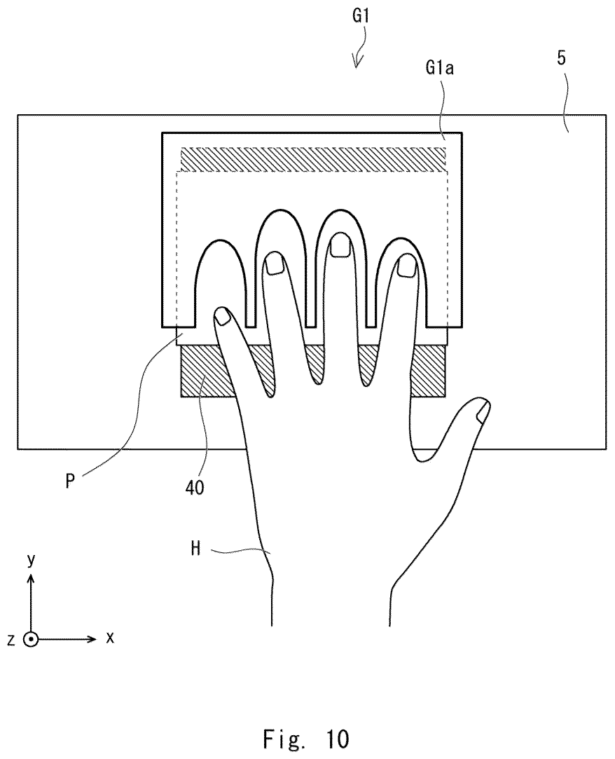

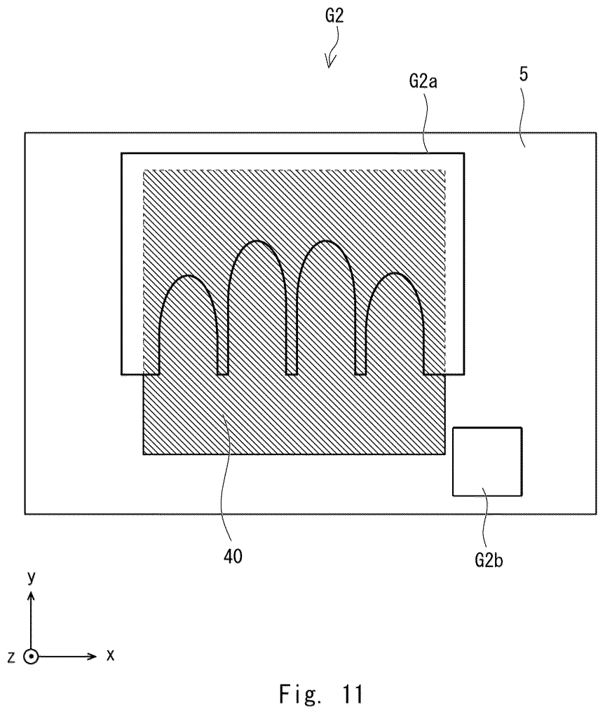

FIG. 10 is a diagram illustrating an example in which the user presents the reading target object using the guide unit G1. FIG. 10 illustrates a state in which the user inserts the reading target object P into the finger guide member G1a and places the hand H on the reading target object P. The reading target object P is, for example, a passport.

As illustrated in the figure, the user inserts the reading target object P into the insertion port, and arranges the hand H such that the position of the finger of the user is aligned with the position of the finger guided by the finger guide member G1a. The posture of the hand H is not limited to the illustrated state. The hand H can be appropriately changed according to the position of the biometric information reading apparatus 30 or the like.

The user may place the hand H on the reading target object P or may lift the hand H from the reading target object P. In addition, although the palm faces downward in the figure, the palm may face upward. In the drawing, the hand presenting the reading target object P is the left hand, but the hand may be the right hand.

The biometric information reading apparatus 30 can be set in advance so that when the user places a finger, the finger is in focus. Alternatively, the biometric information reading apparatus 30 may have an autofocus function so as to automatically focus.

When the user places a finger on the reading target object P, the finger touches the reading target object P. Therefore, the user can present the hand and the reading target object P without bringing the finger into contact with the finger guide member G1a or the mounting table 5.

As described above, according to the information processing apparatus 10 according to the present example embodiment, the guide unit G1 can guide the hand and the reading target object to a state in which the biometric information can be read from the user's hand and the identification information can be read from the reading target object. Furthermore, by including the guide unit G1, the information processing apparatus 10 can guide the hand and the reading target object so that the user can more intuitively grasp the position of the hand and the reading target object.

### Fourth Example Embodiment

Next, a fourth example embodiment will be described. The fourth example embodiment is different from the second example embodiment described above in the aspect of the guide unit 18. Since the configuration other than the guide unit 18 is similar to that of the second example embodiment, description of overlapping contents is omitted.

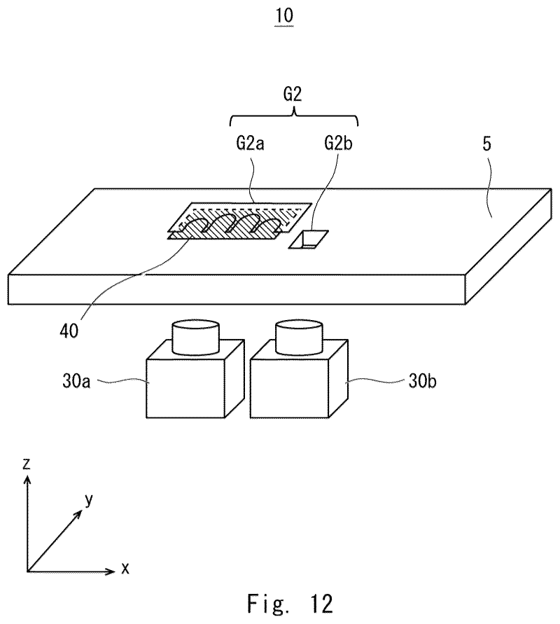

The guide unit G2 according to the present example embodiment will be described with reference to FIG. 11. FIG. 11 is a diagram illustrating a configuration of the guide unit G2. The guide unit G2 is an example of the guide unit 18 described above. In the guide unit G2, the guide unit G1 further includes a finger guide member for guiding a finger different from the finger guided by the finger guide member G1a in addition to the finger guide member G1a. As illustrated in the figure, the guide unit G2 is provided on the mounting table 5.

The guide unit G2 includes a first finger guide unit G2a that guides a first finger of a hand that presents a reading target object, and a second finger guide unit G2b that guides a second finger of the hand. For example, a first finger guide unit G2a is configured using finger guide member G1a described above. Second finger guide unit G2b is formed by using a concave portion provided in the mounting table 5 for inserting the second finger.

The concave portion can be provided at a position and in a shape where the wall surface forming the concave portion and the second finger do not come into contact with each other in a state where the user places the first finger on first finger guide unit G2a and inserts the second finger into second finger guide unit G2b. The concave portion may be a through hole penetrating the mounting table 5 in the thickness direction. Each of the first finger and the second finger may include a plurality of fingers. For example, the first finger is four fingers (index finger, middle finger, ring finger, and little finger) other than the thumb, and the second finger is the thumb.

For example, it is assumed that the biometric information reading apparatus 30 reads the fingerprints of the five fingers including the thumb using the guide unit G1 of the third example embodiment described above. When the user places the thumb on the mounting table 5 together with the palm, the outer side (the side opposite to the index finger) of the thumb comes into contact with the mounting table 5, but the inner side (the index finger side) does not come into contact with the mounting table 5. Therefore, the biometric information reading apparatus 30 acquires a fingerprint image in which one side of the thumb is crushed. In this case, since the fingerprint image of the thumb cannot be appropriately acquired, the authentication accuracy may be deteriorated.

On the other hand, since the guide unit G2 includes the first finger guide unit G2a and the second finger guide unit G2b, the biometric information reading apparatus 30 can read the biometric information of the thumb from an angle different from those of the other four fingers. As described above, the biometric information reading apparatuses 30a and 30b read the biometric information of different fingers, whereby the information processing apparatus 10 can appropriately acquire the biometric information.

Since the second finger guide unit G2b is formed of the concave portion provided in the mounting table 5, the biometric information reading apparatus 30 can read the biometric information on the second finger while the second finger and the mounting table 5 are not in contact with each other.

FIG. 12 is a diagram illustrating a configuration of the information processing apparatus 10 in a case where the guide unit G2 is provided as the guide unit 18. As illustrated in the figure, the information processing apparatus 10 includes two biometric information reading apparatuses 30a and 30b.

The biometric information reading apparatus 30a reads the biometric information on the finger guided by the first finger guide unit G2a, and the biometric information reading apparatus 30b reads the biometric information on the finger guided by the second finger guide unit G2b. In the drawing, the biometric information reading apparatus 30 is provided below the mounting table 5, but the same applies to a case where the biometric information reading apparatus is provided above the mounting table 5.

In addition, in FIG. 12, the biometric information reading apparatuses 30a and 30b are illustrated to be parallel to the mounting table 5, but the present disclosure is not limited thereto. For example, the biometric information reading apparatus 30b that reads the biometric information of the thumb may be provided to be inclined at an angle at which a fingerprint or the like of the thumb inserted into the second finger guide unit G2b can be read.

In FIG. 12, two biometric information reading apparatuses 30a and 30b read the pieces of biometric information of the fingers corresponding to the first finger guide unit G2a and the second finger guide unit G2b, respectively. However, as described below, one biometric information reading apparatus 30 may read both.

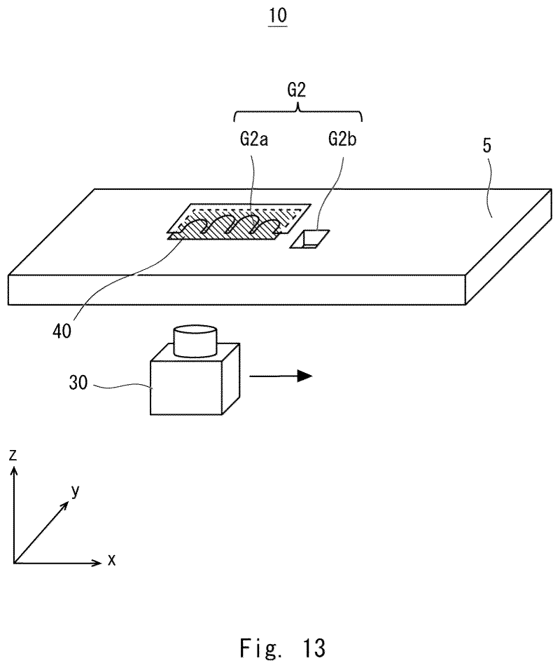

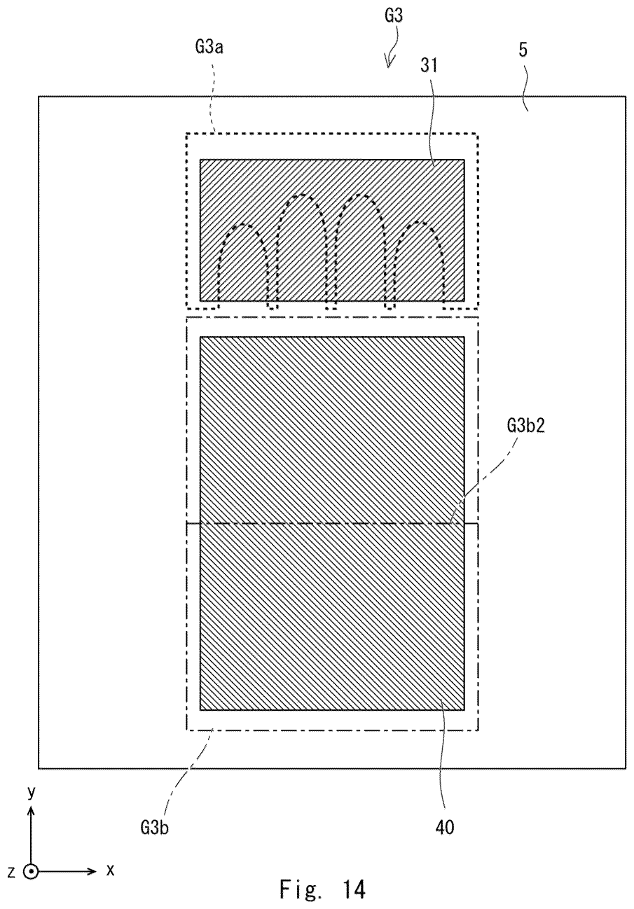

FIG. 13 is a diagram illustrating a configuration of the information processing apparatus 10 in a case where the biometric information reading apparatus 30 reads biometric information at a plurality of locations. For example, the information processing apparatus 10 moves the biometric information reading apparatus 30 by including a drive mechanism for moving the biometric information reading apparatus 30. The biometric information reading apparatus 30 moves at least a position corresponding to the first finger guide unit G2a and a position corresponding to the second finger guide unit G2b. In the drawing, the biometric information reading apparatus 30 is provided below the mounting table 5, but the same applies to a case where the biometric information reading apparatus is provided above the mounting table 5.

An arrow illustrated in FIG. 13 indicates an example of a moving direction of the biometric information reading apparatus 30. The moving direction of the biometric information reading apparatus 30 is not limited thereto. The biometric information reading apparatus 30 may be configured to be movable in the vertical direction, the horizontal direction, or both. Further, the biometric information reading apparatus 30 may be configured to be able to change an angle of a reading surface for reading biometric information.

In this way, even when the information processing apparatus 10 includes one biometric information reading apparatus 30, the biometric information can be read at positions corresponding to the first finger guide unit G2a and the second finger guide unit G2b, respectively.

As described above, according to the information processing apparatus 10 according to the present example embodiment, the guide unit G2 can guide the hand and the reading target object to a state in which the biometric information can be read from the user's hand and the identification information can be read from the reading target object. Furthermore, by including the guide unit G2, the information processing apparatus 10 can guide the hand and the reading target object so that the user can more intuitively grasp the position of the hand and the reading target object. Since the guide unit G2 includes the first finger guide unit G2a and the second finger guide unit G2b, the information processing apparatus 10 can accurately read the biometric information of the hand that presents the reading target object.

Since the first finger and the second finger described above are examples, a combination other than the fingers described above may be used.

### Fifth Example Embodiment

Next, a fifth example embodiment will be described. The fifth example embodiment is different from the second example embodiment described above in the aspect of the guide unit 18. Since the configuration other than the guide unit 18 is similar to that of the second example embodiment, description of overlapping contents is omitted.

The guide unit G3 according to the present example embodiment will be described with reference to FIG. 14. FIG. 14 is a diagram illustrating a configuration of the guide unit G3. The guide unit G3 is an example of the guide unit 18 described above. As illustrated in the figure, the guide unit G3 is provided on the mounting table 5.

Instead of the finger guide member included in the guide unit G1 or G2 described above, the guide unit G3 displays the position of the region where the biometric information can be read and the position of the region where the identification information can be read on the mounting table 5.

As illustrated in FIG. 14, the guide unit G3 includes a first region guide unit G3a and a second region guide unit G3b. The first region guide unit G3a displays the position of the region where the biometric information can be read on the mounting table 5. In the example illustrated in FIG. 14, the region where the biometric information can be read is a biometric information reading window 31.

The biometric information reading window 31 is a region provided on the mounting table 5 for the biometric information reading apparatus 30 to read biometric information. The biometric information reading window 31 may be made of a transparent material such as glass, acrylic, or polycarbonate. The biometric information reading window 31 may be made of another material. The biometric information reading window 31 is provided at a position where the biometric information reading apparatus 30 can read biometric information.

The first region guide unit G3a displays the position of the biometric information reading window 31 on the mounting table 5. For example, the first region guide unit G3a displays the shape of the finger on the mounting table 5 so as to overlap the biometric information reading window 31 such that the hand presenting the reading target object is arranged on the biometric information reading window 31.

In this way, the first region guide unit G3a can guide the user's hand such that the hand presenting the reading target object is arranged on the biometric information reading window 31. Note that the first region guide unit G3a may display a shape including not only the finger of the hand but also the palm such that, for example, up to the palm is arranged on the biometric information reading window 31.

In addition, the first region guide unit G3a may be displayed so as to indicate the position itself of the biometric information reading window 31. For example, when the biometric information reading window 31 is a rectangular region as illustrated in the figure, the first region guide unit G3a may display four sides of the rectangular region.

The second region guide unit G3b displays the position of the region where the identification information of the reading target object can be read on the mounting table 5. Specifically, the second region guide unit G3b displays the position of the reading surface of the identification information reading apparatus 40 on the mounting table 5. In FIG. 14, the reading surface is illustrated as the identification information reading apparatus 40.

For example, the second region guide unit G3b displays a rectangular region including the reading surface. In a case where it is necessary to open and present a predetermined page of the reading target object, as illustrated in the figure, the second region guide unit G3b may display an auxiliary line G3b2 for dividing the rectangular region. As a result, the user can intuitively grasp the position where the reading target object is presented.

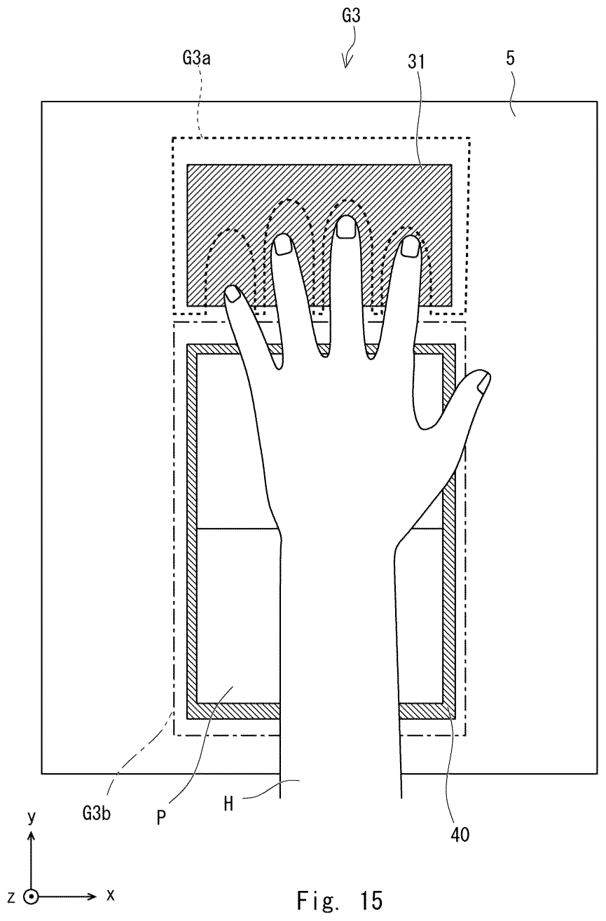

FIG. 15 is a diagram illustrating an example in which the user presents the reading target object using the guide unit G3. The user places the reading target object P on the reading surface of the identification information reading apparatus 40 according to the second region guide unit G3b, and places the hand H on the reading target object P according to the first region guide unit G3a.

By placing the hand H on the reading target object P, the user can place the finger above the biometric information reading window 31 with the finger of the hand lifted from the mounting table 5. Therefore, the information processing apparatus 10 can perform biometric authentication without bringing the user's hand H into contact with the mounting table 5. The biometric information reading apparatus 30 reads biometric information of a finger disposed above the biometric information reading window 31.

Similarly to FIG. 10, the posture of the hand H is not limited to the illustrated state. The hand H can be appropriately changed according to the position of the biometric information reading apparatus 30 or the like. For example, the user may place the hand H on the reading target object P or may lift the hand H from the reading target object P. Furthermore, the user may turn the palm upward, or may present the right hand instead of the left hand. The biometric information reading apparatus 30 can be set in advance so that when the user places a finger, the finger is in focus. Alternatively, the biometric information reading apparatus 30 may have an autofocus function so as to automatically focus.

The guide unit G3 can display the first region guide unit G3a and the second region guide unit G3b on the mounting table 5 using various methods. For example, the guide unit G3 generates a projection image for projecting each of the first region guide unit G3a and the second region guide unit G3b onto the mounting table 5, and outputs the projection image to the output unit 14. The output unit 14 outputs the projection image to the mounting table 5. The user can recognize the position of the biometric information reading window 31 and the position of the reading surface of the identification information reading apparatus 40 by visually recognizing the projection image.

Furthermore, the projection image may include an image of the above-described arrow symbol. In this way, even in a case where the hand or the reading target object is not located in the readable region, the user can intuitively grasp the fact. In addition, the user can move the hand and the reading target object to appropriate positions according to the projected arrow symbol.

The present disclosure is not limited to the above, and the guide unit G3 may be configured to display the first region guide unit G3a and the second region guide unit G3b on the mounting table 5 using printing, a tape, or the like.

As described above, according to the information processing apparatus 10 according to the present example embodiment, the guide unit G3 can guide the hand and the reading target object to a state in which the biometric information can be read from the user's hand and the identification information can be read from the reading target object. Furthermore, by including the guide unit G3, the information processing apparatus 10 can guide the hand and the reading target object so that the user can more intuitively grasp the position of the hand and the reading target object.

Since the guide unit G3 includes the first region guide unit G3a and the second region guide unit G3b, the possibility that the user's hand comes into contact with the member or the like can be further reduced as compared with the case where the above-described finger guide member or the like is provided.

### Sixth Example Embodiment

Next, a sixth example embodiment will be described. The sixth example embodiment is different from the second example embodiment described above in the aspect of the guide unit 18. Since the configuration other than the guide unit 18 is similar to that of the second example embodiment, description of overlapping contents is omitted.

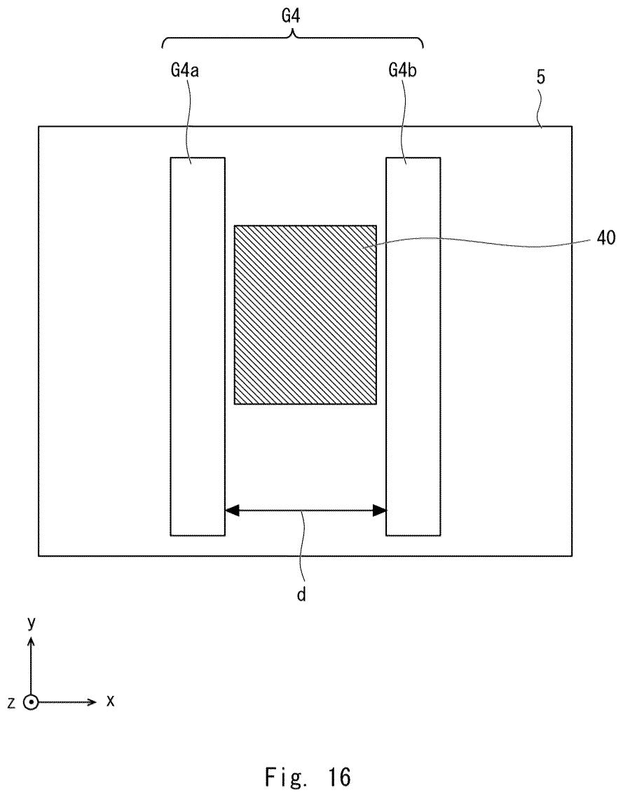

The guide unit G4 according to the present example embodiment will be described with reference to FIG. 16. FIG. 16 is a diagram illustrating a configuration of the guide unit G4. The guide unit G4 is an example of the guide unit 18 described above. As illustrated in the figure, the guide unit G4 is provided on the mounting table 5.

As illustrated in FIG. 16, the guide unit G4 includes a groove that guides a finger of a hand that grips a reading target object, unlike the above-described example embodiment. The groove includes a first groove G4a that guides the first finger and a second groove G4b that guides the second finger. Each of the first finger and the second finger may include a plurality of fingers. For example, the first finger is four fingers (index finger, middle finger, ring finger, and little finger) other than the thumb, and the second finger is the thumb.

The first groove G4a and the second groove G4b are provided on the mounting table 5 so as to sandwich the reading surface of the identification information reading apparatus 40. In the example illustrated in FIG. 16, each of the first groove G4a and the second groove G4b is disposed such that the longitudinal direction is parallel to the y-axis. That is, the first groove G4a and the second groove G4b are provided to extend in the longitudinal direction as viewed from the user.

The present disclosure is not limited thereto, and the first groove G4a and the second groove G4b may be disposed so as to be parallel to the x-axis. That is, the first groove G4a and the second groove G4b may be provided so as to extend in the lateral direction as viewed from the user. In addition, the first groove G4a and the second groove G4b may each have an angle with the x-axis or the y-axis so that the user can easily present the reading target object.

The user presents the reading target object by holding the reading target object over the reading surface of the identification information reading apparatus 40. At this time, a part of the hand presenting the reading target object enters the first groove G4a, and a part of the hand enters the second groove G4b. There may be a finger that does not enter either the first groove G4a or the second groove G4b.

The biometric information reading apparatus 30 reads biometric information of a hand that has entered the first groove G4a or the second groove G4b. The identification information reading apparatus 40 reads the identification information from the reading target object presented by the hand.

The first groove G4a and the second groove G4b can be provided at positions and shapes where the first finger and the second finger do not come into contact with wall surfaces forming the respective grooves in a state where the user causes the first finger to enter the first groove G4a and the second finger to enter the second groove G4b. The first groove G4a and the second groove G4b may be through holes penetrating the mounting table 5 in the thickness direction.

In addition, the first groove G4a and the second groove G4b can be arranged such that the distance d between the first groove G4a and the second groove G4b is smaller than the lateral width of the reading target object. For example, when the reading target object is an information terminal such as a smartphone, the first groove G4a and the second groove G4b can be disposed such that the distance d is smaller than an average width of the smartphone. In this way, the user can easily take out the reading target object after reading the hand and the reading target object. The positions and shapes of the first groove G4a and the second groove G4b are not limited to those described above, and can be appropriately changed.

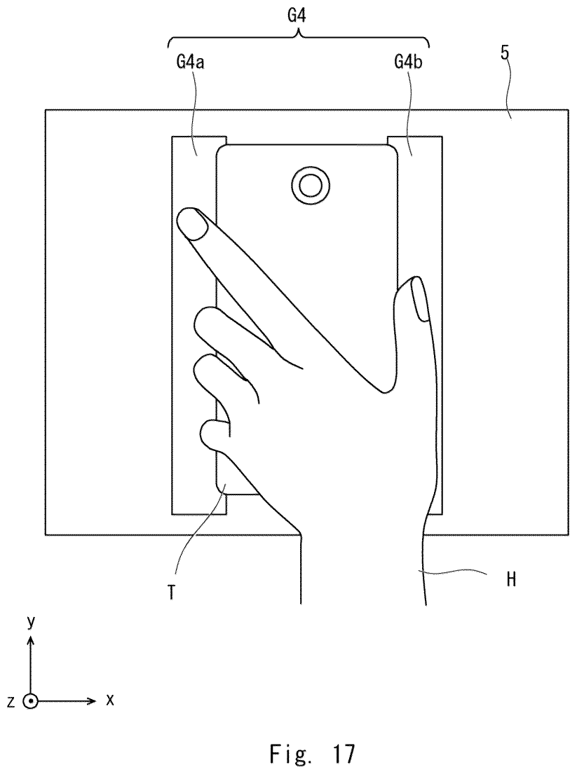

FIG. 17 is a diagram illustrating an example in which the user presents the reading target object T using the guide unit G4. The reading target object T is, for example, an information terminal such as a smartphone. The reading target object T may be a passport or the like.

While holding the reading target object T with the hand H, the user brings the reading target object T close to the reading surface of the identification information reading apparatus 40 according to the guide unit G4. For example, the user places the gripped reading target object T on the reading surface of the identification information reading apparatus 40. Alternatively, the user may bring the reading target object T close to the reading surface in a floating state and hold the reading target object T over the reading surface. While holding the reading target object T, the user causes the first finger to enter the first groove G4a and causes the second finger to enter the second groove G4b.

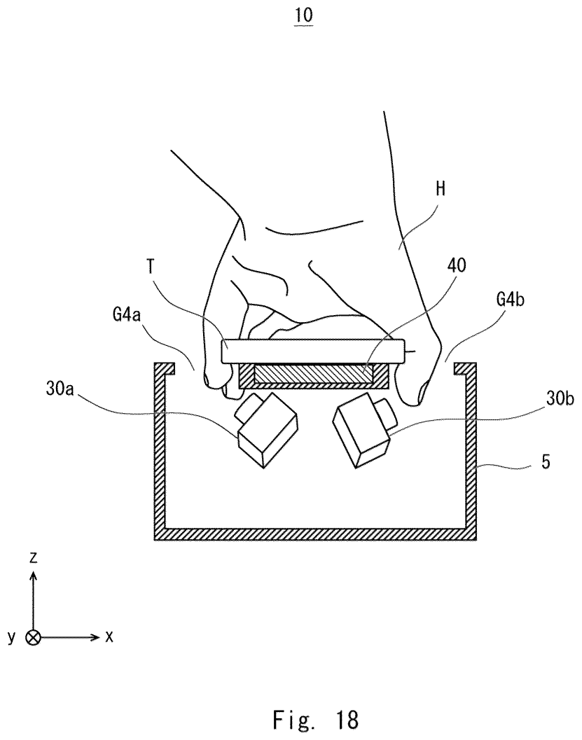

FIG. 18 is a diagram illustrating the information processing apparatus 10 when the state illustrated in FIG. 17 is viewed from the user side (y-axis minus direction side). As illustrated in FIG. 18, the biometric information reading apparatuses 30a and 30b are provided at positions where the biometric information of the hand H of the user can be read in a state where the user places the reading target object T on the reading surface of the identification information reading apparatus 40.

In this state, the biometric information reading apparatus 30a reads biometric information of the first finger having entered the first groove G4a, and the biometric information reading apparatus 30b reads biometric information of the second finger having entered the second groove G4b. For example, the biometric information reading apparatuses 30a and 30b read the biometric information by imaging the finger that has entered the first groove G4a or the second groove G4b from the palm side toward the finger side of the user. The identification information reading apparatus 40 reads the identification information from the reading target object T placed on the reading surface.

Note that, although the two biometric information reading apparatuses 30a and 30b have been described here, as described with reference to FIG. 13, reading may be performed at a plurality of reading positions by moving one biometric information reading apparatus 30. In this case, the biometric information reading apparatus 30 reads the biometric information of the finger that has entered the first groove G4a and the second groove G4b.

Note that the posture of the hand H is not limited to the illustrated state. The hand H can be appropriately changed according to the position of the biometric information reading apparatus 30 or the like. The user may hold the reading target object T with the right hand instead of the left hand to present the reading target object T. In addition, the biometric information reading apparatuses 30a and 30b can be set in advance such that when the user places a finger, the finger is in focus. Alternatively, the biometric information reading apparatuses 30a and 30b may be configured to automatically focus.

As described above, according to the information processing apparatus 10 according to the present example embodiment, the guide unit G4 can guide the hand and the reading target object to a state in which the biometric information can be read from the user's hand and the identification information can be read from the reading target object. Furthermore, by providing the guide unit G4, the information processing apparatus 10 can guide the user's hand and the reading target object in a state where the user holds the reading target object. As a result, the authentication system 1 can perform the biometric authentication of the user more efficiently.

The above-described example embodiments can be executed in any combination. For example, the information processing apparatus 10 may include a guide unit 18 obtained by combining the second example embodiment and any one of the third to sixth example embodiments. For example, the information processing apparatus 10 may guide the user's hand and the reading target object using the guide member described in the third to sixth example embodiments together with the characters, sounds, guidance images, or the like described in the second example embodiment.

### <Hardware Configuration Example>

The functional configuration units of the information processing apparatus 10 and the authentication apparatus 50 according to the disclosure may be implemented by hardware (for example, a hard-wired electronic circuit or the like) that implements the functional configuration units, or may be implemented by a combination of hardware and software (for example, a combination of an electronic circuit and a program that controls the electronic circuit or the like). Hereinafter, a case where each functional configuration unit such as the information processing apparatus 10 is realized by a combination of hardware and software will be described.

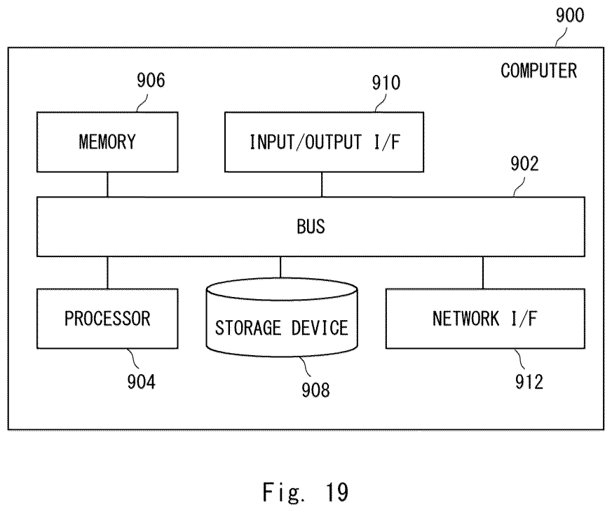

FIG. 19 is a block diagram illustrating a hardware configuration of a computer 900 that implements the information processing apparatus 10 and the like. The computer 900 may be a dedicated computer designed to realize the information processing apparatus 10 and the like, or may be a general-purpose computer. The computer 900 may be a portable computer such as a smartphone and a tablet terminal.

For example, by installing a predetermined application in the computer 900, each function of the information processing apparatus 10 and the like is realized in the computer 900. The application is configured by a program for realizing a functional configuration unit such as the information processing apparatus 10.

The computer 900 includes a bus 902, a processor 904, a memory 906, a storage device 908, an input/output interface 910, and a network interface 912. The bus 902 is a data transmission path for the processor 904, the memory 906, the storage device 908, the input/output interface 910, and the network interface 912 to transmit and receive data to and from each other. However, a method of connecting the processor 904 and the like to each other is not limited to the bus connection.

The processor 904 is a variety of processors such as a central processing unit (CPU), a graphics processing unit (GPU), and a field-programmable gate array (FPGA). The memory 906 is a main storage device realized by using a random access memory (RAM) or the like. The storage device 908 is an auxiliary storage device realized by using a hard disk, a solid state drive (SSD), a memory card, a read only memory (ROM), or the like.

The input/output interface 910 is an interface for connecting the computer 900 and an input/output apparatus. For example, an input apparatus such as a keyboard and an output apparatus such as a display apparatus are connected to the input/output interface 910.

The network interface 912 is an interface for connecting the computer 900 to a network. The network may be a local area network (LAN) or a wide area network (WAN).

The storage device 908 stores a program for realizing each functional configuration unit such as the information processing apparatus 10 (a program for realizing the above-described application). The processor 904 reads the program into the memory 906 and executes the program to implement each functional configuration unit such as the information processing apparatus 10.

Each of the processors executes one or more programs including a command group for causing a computer to perform the algorithm described with reference to the drawings. The program includes a command group (or software codes) for causing the computer to perform one or more functions that have been described in the example embodiments in a case where the program is read by the computer. The program may be stored in various types of non-transitory computer-readable media or tangible storage media. As an example and not by way of limitation, a non-transitory computer-readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disc, or other optical disc storage. In addition, as an example and not by way of limitation, non-transitory computer-readable media or tangible storage media include magnetic cassettes, magnetic tape, magnetic disk storage, or other magnetic storage devices. The program may be transmitted on various types of transitory computer-readable media or communication media. As an example and not by way of limitation, transitory computer-readable or communication media include electrical, optical, acoustic, or other forms of propagated signals.

Note that the disclosure is not limited to the above-described example embodiments, and can be appropriately modified without departing from the gist.

Some or all of the above-described example embodiments may be described as in the following Supplementary Notes, but are not limited to the following Supplementary Notes.

### (Supplementary Note 1)

An information processing apparatus including:
a detection unit that detects a hand presenting a reading target object including identification information of a user; and
a reading unit that reads biometric information from an image obtained by imaging the detected hand and reads the identification information from the reading target object presented by the hand.

### (Supplementary Note 2)

The information processing apparatus according to supplementary note 1, in which the reading unit determines whether quality of the biometric information is equal to or higher than a predetermined value and reads the identification information when determining that the quality is equal to or higher than the predetermined value.

### (Supplementary Note 3)

The information processing apparatus according to supplementary note 1 or 2, in which the detection unit detects the hand from an image obtained by imaging the hand presenting the reading target object on a predetermined mounting table.

### (Supplementary Note 4)

The information processing apparatus according to any one of supplementary notes 1 to 3, in which the detection unit detects the hand presenting the reading target object on a predetermined mounting table based on distance measurement data acquired from a distance measurement sensor.

### (Supplementary Note 5)

The information processing apparatus according to any one of supplementary notes 1 to 4, in which the detection unit detects the hand presenting the reading target object based on pressure data acquired from a pressure sensor provided on a predetermined mounting table.

### (Supplementary Note 6)

The information processing apparatus according to any one of supplementary notes 1 to 5, further including a guide unit that guides the hand and the reading target object to a state in which the biometric information can be read from the hand and the identification information can be read from the reading target object.

### (Supplementary Note 7)

The information processing apparatus according to supplementary note 6, in which the guide unit generates guidance information for guiding the hand and the reading target object and causes the guidance information to be output using a character, an image, a voice, or vibration.

### (Supplementary Note 8)

The information processing apparatus according to supplementary note 6 or 7, in which the guide unit is configured using a finger guide member having a shape corresponding to a shape of a finger, and guides the finger of the hand presenting the reading target object to a predetermined mounting table.

### (Supplementary Note 9)

The information processing apparatus according to supplementary note 8, in which
the guide unit includes:
a first finger guide unit for guiding a first finger of the hand; and
a second finger guide unit for guiding a second finger of the hand,
the first finger guide unit is configured using the finger guide member, and
the second finger guide unit is configured using a concave portion provided in the mounting table and into which the second finger is inserted.

### (Supplementary Note 10)

The information processing apparatus according to any one of supplementary notes 6 to 9, in which the guide unit displays a position of a region from which the biometric information can be read and a position of a region from which the identification information can be read on a predetermined mounting table.

### (Supplementary Note 11)

The information processing apparatus according to any one of supplementary notes 6 to 10, in which the guide unit includes a groove that guides a finger of the hand gripping the reading target object.

### (Supplementary Note 12)

The information processing apparatus according to any one of supplementary notes 1 to 11, further including authentication control unit that controls biometric authentication of the user using the biometric information and the identification information.

### (Supplementary Note 13)

An authentication system including:
an information processing apparatus; and
an authentication apparatus, in which
the information processing apparatus includes:
a detection unit that detects a hand presenting a reading target object including identification information of a user; and
a reading unit that reads biometric information from an image obtained by imaging the detected hand and reads the identification information from the reading target object presented by the hand, and
the authentication apparatus is configured to:
acquire the biometric information and the identification information from the information processing apparatus and perform biometric authentication of the user based on the biometric information and the identification information.

### (Supplementary Note 14)

The authentication system according to supplementary note 13, in which the reading unit determines whether the quality of the biometric information is equal to or higher than a predetermined value, and reads the identification information when determining that the quality is equal to or higher than the predetermined value.

### (Supplementary Note 15)

An information processing method for causing a computer to execute:
a detection step of detecting a hand that presents a reading target object including identification information of a user; and
a reading step of reading biometric information from an image obtained by imaging the detected hand and reading the identification information from the reading target object presented by the hand.

### (Supplementary Note 16)

The information processing method according to supplementary note 15, in which in the reading step, it is determined whether a quality of the biometric information is equal to or higher than a predetermined value, and the identification information is read in a case where it is determined that the quality is equal to or higher than the predetermined value.

### (Supplementary Note 17)

A program for causing a computer to execute the steps of:
a detection step of detecting a hand that presents a reading target object including identification information of a user; and
a reading step of reading biometric information from an image obtained by imaging the detected hand and reading the identification information from the reading target object presented by the hand.

### (Supplementary Note 18)

The program according to supplementary note 17, in which in the reading step, it is determined whether a quality of the biometric information is equal to or higher than a predetermined value, and the identification information is read in a case where it is determined that the quality is equal to or higher than the predetermined value.

Although the invention of the present application has been described above with reference to the example embodiments, the invention of the present application is not limited to the above. Various modifications that can be understood by those skilled in the art can be made to the configuration and details of the invention of the present application within the scope of the invention.

This application claims priority based on Japanese Patent Application No. 2022-088392 filed on May 31, 2022, the entire disclosure of which is incorporated herein.

### REFERENCE SIGNS LIST

1 AUTHENTICATION SYSTEM
5 MOUNTING TABLE
10 INFORMATION PROCESSING APPARATUS
11 DETECTION UNIT
12 READING CONTROL UNIT
13 AUTHENTICATION CONTROL UNIT
14 OUTPUT UNIT
15 STORAGE UNIT
18 GUIDE UNIT
20 DETECTION SENSOR
30, 30a, 30b BIOMETRIC INFORMATION READING APPARATUS
31 BIOMETRIC INFORMATION READING WINDOW
40 IDENTIFICATION INFORMATION READING APPARATUS
50 AUTHENTICATION APPARATUS
51 AUTHENTICATION STORAGE UNIT
52 FEATURE IMAGE EXTRACTION UNIT
53 FEATURE POINT EXTRACTION UNIT
54 REGISTRATION UNIT
55 AUTHENTICATION UNIT
100 INFORMATION PROCESSING APPARATUS
101 DETECTION UNIT
102 READING UNIT
900 COMPUTER
902 BUS
904 PROCESSOR
906 MEMORY
908 STORAGE DEVICE
910 INPUT/OUTPUT INTERFACE
912 NETWORK INTERFACE
d DISTANCE
G1 to G4 GUIDE UNIT
G1a FINGER GUIDE MEMBER
G2a FIRST FINGER GUIDE UNIT
G2b SECOND FINGER GUIDE UNIT
G3a FIRST REGION GUIDE UNIT
G3b SECOND REGION GUIDE UNIT
G3b2 AUXILIARY LINE
G4a FIRST GROOVE
G4b SECOND GROOVE
H HAND
N NETWORK
P, T READING TARGET OBJECT

What is claimed is:

1. An information processing apparatus comprising:
at least one memory storing instructions; and
at least one processor configured to execute the instructions to:
detect a hand presenting a reading target object including identification information of a user; and
read biometric information from an image obtained by imaging the detected hand and read the identification information from the reading target object presented by the hand.

2. The information processing apparatus according to claim 1, wherein the at least one processor is further configured to execute the instructions to determine whether quality of the biometric information is equal to or higher than a predetermined value and read the identification information when determining that the quality is equal to or higher than the predetermined value.

3. The information processing apparatus according to claim 1, wherein the at least one processor is further configured to execute the instructions to detect the hand from an image obtained by imaging the hand presenting the reading target object on a predetermined mounting table.

4. The information processing apparatus according to claim 1, wherein the at least one processor is further configured to execute the instructions to detect the hand presenting the reading target object on a predetermined mounting table based on distance measurement data acquired from a distance measurement sensor.

5. The information processing apparatus according to claim 1, wherein the at least one processor is further configured to execute the instructions to detect the hand presenting the reading target object based on pressure data acquired from a pressure sensor provided on a predetermined mounting table.

6. The information processing apparatus according to claim 1, further comprising guide unit for guiding the hand and the reading target object to a state in which the biometric information can be read from the hand and the identification information can be read from the reading target object.

7. The information processing apparatus according to claim 6, wherein the guide unit generates guidance information for guiding the hand and the reading target object and causes the guidance information to be output using a character, an image, a voice, or vibration.

8. The information processing apparatus according to claim 6, wherein the guide unit is configured using a finger guide member having a shape corresponding to a shape of a finger, and guides the finger of the hand presenting the reading target object to a predetermined mounting table.

9. The information processing apparatus according to claim 8, wherein
the guide unit includes:
first finger guide unit for guiding a first finger of the hand; and
second finger guide unit for guiding a second finger of the hand,
the first finger guide unit is configured using the finger guide member, and
the second finger guide unit is configured using a concave portion provided in the mounting table and into which the second finger is inserted.

10. The information processing apparatus according to claim 6, wherein the guide unit displays a position of a region from which the biometric information can be read and a position of a region from which the identification information can be read on a predetermined mounting table.

11. The information processing apparatus according to claim 6, wherein the guide unit includes a groove that guides a finger of the hand gripping the reading target object.

12. The information processing apparatus according to claim 1, wherein the at least one processor is further configured to execute the instructions to control biometric authentication of the user using the biometric information and the identification information.

13-14. (canceled)

15. An information processing method for causing a computer to execute:
detecting a hand that presents a reading target object including identification information of a user; and
reading biometric information from an image obtained by imaging the detected hand and reading the identification information from the reading target object presented by the hand.

16. The information processing method according to claim 15, wherein in the reading the identification information, it is determined whether a quality of the biometric information is equal to or higher than a predetermined value, and the identification information is read in a case where it is determined that the quality is equal to or higher than the predetermined value.

17. A non-transitory computer-readable medium having a program stored thereon, the program causing a computer to execute:
detecting a hand that presents a reading target object including identification information of a user; and
reading biometric information from an image obtained by imaging the detected hand and reading the identification information from the reading target object presented by the hand.

18. The non-transitory computer-readable medium according to claim 17, wherein in the reading the identification information, it is determined whether a quality of the biometric information is equal to or higher than a predetermined value, and the identification information is read in a case where it is determined that the quality is equal to or higher than the predetermined value.
